(19) United States
(12) Patent Application Publication
(10) Pub. No.: US 2021/0382789 A1
(43) Pub. Date: Dec. 9, 2021

(54) METHOD FOR PROTECTING SYSTEM FROM BEING POWERED OFF DURING UPGRADE AND TERMINAL DEVICE

(71) Applicant: AMLOGIC (SHANGHAI) CO., LTD., Shanghai (CN)

(72) Inventors: Zhigang YU, Shanghai (CN); Yihui WU, Shanghai (CN); Fuyao ZHONG, Shanghai (CN); Tao DONG, Shanghai (CN)

(73) Assignee: AMLOGIC (SHANGHAI) CO., LTD., Shanghai (CN)

(21) Appl. No.: 16/324,607

(22) PCT Filed: Sep. 17, 2018
(86) PCT No.: PCT/CN2018/105978

§ 371 Date: Feb. 11, 2019

(30) Foreign Application Priority Data
Sep. 26, 2017 (CN) 201710882851.7

(51) Int. Cl. G06F 11/14; G06F 1/30; G06F 8/65; G06F 8/61

(52) U.S. Cl. CPC G06F 11/1435; G06F 11/1438; G06F 8/63; G06F 8/65; G06F 1/30

(57) ABSTRACT

A method for protecting a system from being powered off abnormally during an upgrade, which is applied to a system upgrade of a terminal device, comprises: acquiring a startup offset value of one of the plurality of storage partitions; when the startup offset value is the first offset value, starting the first system image file; acquiring an upgrade file, performing an upgrade operation on the second system image file in the current storage partition by using the acquired upgrade file, and setting the startup offset value as the second offset value when the upgrade is successfully completed; and continuing to perform the upgrade operation on the first system image file, and setting the startup offset value as the first offset value when the upgrade is successfully completed. The terminal device is powered off when upgrade operation is performed so that the system of the terminal device cannot be started normally.

### BACKGROUND OF THE INVENTION

### 1. Field of the Invention

The invention relates to the field of communication technology, and more particularly, to a method for protecting a system from being powered off abnormally during an upgrade and a terminal device.

### 2. Description of the Related Art

A system upgrade refers to an event that aims to recover and optimize the system of a terminal device. When the existing terminal device is being upgraded, a prompt message saying “it is being upgraded now, so please do not cut off the power” will pop up to inform a user that the system is being upgraded. Otherwise, power failure may occur due to the user's shutting down the system, and the system may be damaged and rendered unusable (that is, the system fails to start properly) when being upgraded halfway. Generally, the user's action is out of control, and a sudden power failure is also unpredictable. Accordingly, power failure during an upgrade is unavoidable, and the prompt message may only help to reduce the incidence rate of power failure, but fail to solve the problem that the power failure occurring during the upgrade may make the system rendered unusable. As the capacity of the flash storage medium is increased, a corresponding measure can be taken to increase the number of backup partitions. In this manner, when one of the plurality of storage partitions is damaged, the backup partition can be used to restore the system image file of the damaged storage partition. However, for the terminal device which has been manufactured a lot, in order to ensure a downward compatibility, it is impracticable to increase the number of partitions, and it may pose a relatively great risk if it is changed from one partition to another during the upgrade operation.

### SUMMARY OF THE INVENTION

In the prior art, given that problems occur in the upgrade process of the terminal device in the event of power failure, the present invention provides a method for keeping the system image file in the storage partition remain unaffected and a terminal device, that is to say, the system image file can be started successfully even power failure occurs during the upgrade operation of the terminal device.

The technical solutions are as follows.

A method for protecting a system from being powered off abnormally during an upgrade, which is applied to a system upgrade of a terminal device, wherein the terminal device comprises a plurality of storage partitions, each of the plurality of storage partitions stores a first system image file, a second system image file, a first offset value corresponding to the first system image file, and a second offset value corresponding to the second system image file respectively; and the method comprises the steps of:

Step S1, acquiring a startup offset value of one of the plurality of storage partitions;

Step S2, when the startup offset value is the first offset value, starting the first system image file;

Step S3, acquiring an upgrade file, performing an upgrade operation on the second system image file in the current storage partition by using the acquired upgrade file, and setting the startup offset value as the second offset value when the upgrade is successfully completed; and

Step S4, continuing to perform the upgrade operation on the first system image file that is started, and setting the startup offset value as the first offset value when the upgrade is successfully completed.

Preferably, as shown in FIG. 2, when the startup offset value is the second offset value, the method performs the steps of:

Step A1, starting the second system image file;

Step A2, acquiring the upgrade file, performing an upgrade operation on the first system image file in the current storage partition by using the acquired upgrade file, and setting the startup offset value as the first offset value when the upgrade is successfully completed; and

Step A3, continuing to perform the upgrade operation on the second system image file that is started, and setting the startup offset value as the second offset value when the upgrade is successfully completed.

Preferably, in Step S3, the step of performing the upgrade operation on the second system image file further comprises the steps of:

Step S31, determining whether the second system image file is successfully upgraded,

if the result shows “YES”, turning to Step S32;

if the result shows “NO”, turning to Step S33;

Step S32, after setting the startup offset value as the second offset value, turning to Step S4;

Step S33, generating a prompt message indicating that the upgrade fails, and exiting.

Preferably, in Step S4, the step of performing the upgrade operation on the first system image file that is started further comprises the steps of:

Step S41, determining whether the first system image file is successfully upgraded,

if the result shows “YES”, turning to Step S42;

if the result shows “NO”, turning to Step S43;

Step S42, setting the startup offset value as the first offset value, and exiting; and

Step S43, after saving the startup offset value as the second offset value, the terminal device starts the second system image file based on the second offset value when restarted.

Preferably, the size of each of the plurality of storage partitions is more than twice the size of the saved first image file, or is more than twice the size of the second image file.

Preferably, the terminal device further comprises a boot partition, and the boot partition is configured for saving a boot loader.

The invention further comprises a terminal device, which is applicable to the above-mentioned method for protecting a system from being powered off abnormally during an upgrade.

The foregoing technical solution has the following advantages or beneficial effects: by saving two system image files in one storage partition, when entering one of the system image files, performing an upgrade operation on another system image file at first, and then performing an upgrade operation on the current system image file. In doing so, even if the upgrade fails due to power failure, the terminal device can be started normally. This overcomes the defect that the terminal device is powered off when upgrade operation of its system is performed so that the system of the terminal device cannot be started normally in the prior art.

### BRIEF DESCRIPTION OF THE DRAWINGS

The accompanying drawings, together with the specification, illustrate exemplary embodiments of the present disclosure, and, together with the description, serve to explain the principles of the present invention.

FIG. 1 is a flowchart of an embodiment of a method for protecting a system from being powered off abnormally during an upgrade according to the present invention;

FIG. 2 is a flowchart of an embodiment entering a second system image file according to an embodiment of a method for protecting a system from being powered off abnormally during an upgrade according to the present invention;

FIG. 3 is a flowchart of an embodiment upgrading a second system image file according to an embodiment of a method for protecting a system from being powered off abnormally during an upgrade according to the present invention; and

FIG. 4 is a flowchart of an embodiment upgrading a first system image file according to an embodiment of a method for protecting a system from being powered off abnormally during an upgrade according to the present invention.

### DETAILED DESCRIPTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, the term “plurality” means a number greater than one.

Hereinafter, certain exemplary embodiments according to the present disclosure will be described with reference to the accompanying drawings.

A method for protecting a system from being powered off abnormally during an upgrade is provided in the technical solution of the present invention.

An embodiment of a method for protecting a system from being powered off abnormally during an upgrade, which is applied to a system upgrade of a terminal device, wherein the terminal device comprises a plurality of storage partitions, each of the plurality of storage partitions stores a first system image file, a second system image file, a first offset value corresponding to the first system image file, and a second offset value corresponding to the second system image file respectively; and as shown in FIG. 1, the method comprises the steps of:

Step S1, acquiring a startup offset value of one of the plurality of storage partitions;

Step S2, when the startup offset value is the first offset value, starting the first system image file;

Step S3, acquiring an upgrade file, performing an upgrade operation on the second system image file in the current storage partition by using the acquired upgrade file, and setting the startup offset value as the second offset value when the upgrade is successfully completed; and

Step S4, continuing to perform the upgrade operation on the first system image file that is started, and setting the startup offset value as the first offset value when the upgrade is successfully completed.

In the prior art, abnormal upgrade is found in the system of the terminal device resulting from the sudden power failure during the upgrade, such that the terminal device cannot be started normally, and thus that it is inconvenient for the increase of the backup partition.

In the present invention, a system image file is stored in each of the plurality of storage partitions, it should be noted that the above-mentioned system image files are two system image files with the same system, and that the system image files hereinafter are referred to as the first system image file and the second system image file for the purpose of distinction from one to another.

When the obtained startup offset value of the system is the first offset value, the first system image file is started, and the second system image file is upgraded by the obtained upgrade file during an upgrade at first. If the second system image file is unsuccessfully upgraded, the startup offset value is the first offset value and the first offset value enters the first system image file when the terminal device is started next time.

After the second system image file is successfully upgraded, setting the startup offset value as the second offset value, and continuing to perform the upgrade operation on the first system image file that is started. If the power failure occurs or the upgrade fails then, the startup offset value is the second offset value and the second offset value enters the second system image file under the condition that the startup offset value is set as the first offset value. By implementing the above-mentioned technical solution, the defect that the terminal device is powered off when upgrade operation of its system is performed so that the system of the terminal device cannot be started normally in the prior art, is overcome.

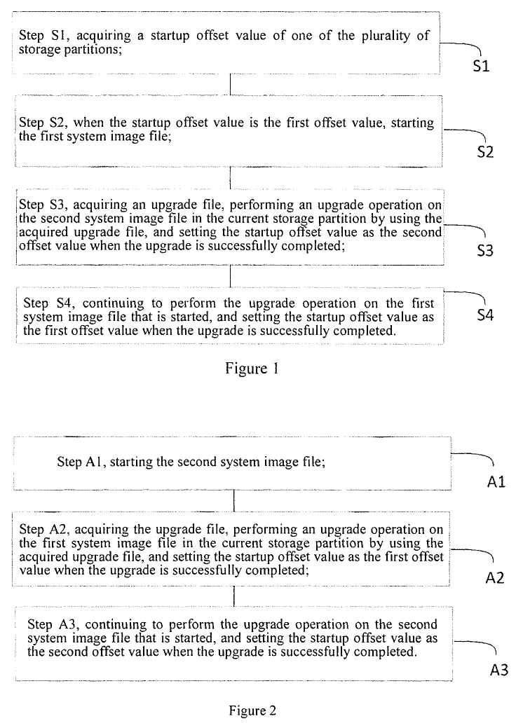

In a preferred embodiment, as shown in FIG. 2, when the startup offset value is the second offset value, the method performs the steps of:

Step A1, starting the second system image file;

Step A2, acquiring the upgrade file, performing an upgrade operation on the first system image file in the current storage partition by using the acquired upgrade file, and setting the startup offset value as the first offset value when the upgrade is successfully completed; and

Step A3, continuing to perform the upgrade operation on the second system image file that is started, and setting the startup offset value as the second offset value when the upgrade is successfully completed.

In the above-mentioned technical solution, if the acquired startup offset value is the second offset value, the startup offset value enters the second system image file, then the upgrade operation is performed on the first system image file. If the upgrade fails, the acquired startup offset value is still the second offset value, and the second offset value enters the second system image file when the terminal device starts again;

when the first system image file is successfully upgraded, setting the startup offset value as the first offset value, and continuing to perform the upgrade operation on the second system image file. If the upgrade fails due to the power failure or other reasons, the startup offset value is the first offset value, and the first offset value enters the first system image file, if the upgrade is successfully completed, the startup offset value shall be set as the second offset value finally.

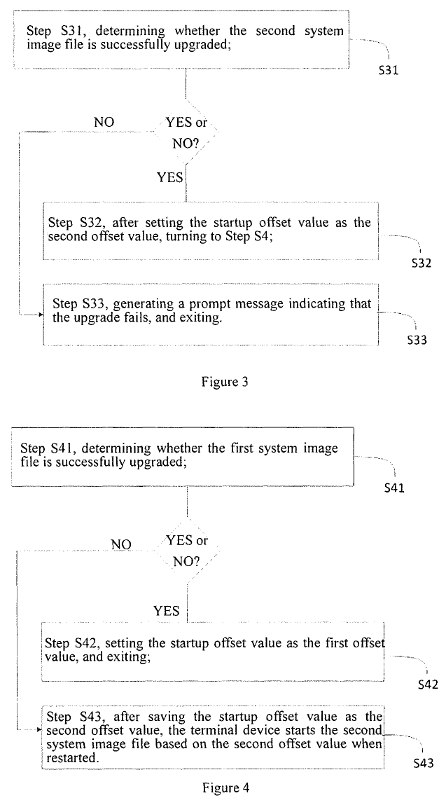

In a preferred embodiment, as shown in FIG. 3, in Step S3, the step of performing the upgrade operation on the second system image file further comprises the steps of:

Step S31, determining whether the second system image file is successfully upgraded,

if the result shows “YES”, turning to Step S32;

if the result shows “NO”, turning to Step S33;

Step S32, after setting the startup offset value as the second offset value, turning to Step S4;

Step S33, generating a prompt message indicating that the upgrade fails, and exiting.

In the above-mentioned technical solution, when the terminal device enters the first system image file to perform the upgrade operation on the second system image file, it must be ensured that only when the second system image file is successfully upgraded can the startup offset value be set as the second offset value. If the upgrade fails, such as power failure occurs, the startup offset value will be set as the first offset value rather than the second offset value.

In Step S33, if the upgrade of the second system image file fails, relevant information informing the user of the upgrade failure will be displayed, and waiting for another upgrade triggering event for an upgrade again.

In a preferred embodiment, as shown in FIG. 4, in Step S4, the step of performing the upgrade operation on the first system image file that is started further comprises the steps of:

Step S41, determining whether the first system image file is successfully upgraded,

if the result shows “YES”, turning to Step S42;

if the result shows “NO”, turning to Step S43;

Step S42, setting the startup offset value as the first offset value, and exiting; and

Step S43, after saving the startup offset value as the second offset value, the terminal device starts the second system image file based on the second offset value when restarted.

In the above-mentioned technical solution, after entering the first system image file, and after the second system image file is successfully upgraded, continuing to perform the upgrade operation on the current first system image file. If the first system image file is successfully upgraded, the startup offset value will be set as the first offset value, such that the terminal device may be enabled to enter the first system image file when restarted;

if the upgrade fails, the startup offset value will be set as the second offset value after the second system image file being successfully upgraded, and the terminal device will enter the second system image file when restarted.

In a preferred embodiment, the size of each of the plurality of storage partitions is more than twice the size of the saved first image file, or is more than twice the size of the second image file.

In the above-mentioned technical solution, in order to ensure that each system image file of the terminal device can be successfully upgraded, the size of each of the plurality of storage partitions must be more than twice the size of the saved system image file to ensure that the size of the storage partition after the upgrading is sufficient for storage of two system image files and their corresponding upgrade files.

In a preferred embodiment, the terminal device further comprises a boot partition, and the boot partition is configured for saving a boot loader.

In the above-mentioned technical solution, after being started, the terminal device will boot the corresponding system image file in the storage partition via the boot loader at first.

The invention further comprises a terminal device, which is applicable to the above-mentioned method for protecting a system from being powered off abnormally during an upgrade.

In the above-mentioned technical solution, by saving two system image files in every storage partition, when entering one of the system image files, the terminal device may perform an upgrade operation on another system image file at first, and then perform an upgrade operation on the current system image file. In doing so, even if the upgrade fails due to power failure, the terminal device can be started normally. This overcomes the defect that the terminal device is powered off when upgrade operation of its system is performed so that the system of the terminal device cannot be started normally in the prior art.

The above descriptions are only the preferred embodiments of the invention, not thus limiting the embodiments and scope of the invention. Those skilled in the art should be able to realize that the schemes obtained from the content of specification and drawings of the invention are within the scope of the invention.

1. A method for protecting a system from being powered off abnormally during an upgrade, which is applied to a system upgrade of a terminal device, wherein the terminal device comprises a plurality of storage partitions, each of the plurality of storage partitions stores a first system image file, a second system image file, a first offset value corresponding to the first system image file, and a second offset value corresponding to the second system image file respectively; and the method comprises the steps of:
Step S1, acquiring a startup offset value of one of the plurality of storage partitions;
Step S2, when the startup offset value is the first offset value, starting the first system image file;
Step S3, acquiring an upgrade file, performing an upgrade operation on the second system image file in the current storage partition by using the acquired upgrade file, and setting the startup offset value as the second offset value when the upgrade is successfully completed; and
Step S4, continuing to perform the upgrade operation on the first system image file that is started, and setting the startup offset value as the first offset value when the upgrade is successfully completed.

2. The method for protecting a system from being powered off abnormally during an upgrade of claim 1, wherein when the startup offset value is the second offset value, the method performs the steps of:
Step A1, starting the second system image file;
Step A2, acquiring the upgrade file, performing an upgrade operation on the first system image file in the current storage partition by using the acquired upgrade file, and setting the startup offset value as the first offset value when the upgrade is successfully completed; and
Step A3, continuing to perform the upgrade operation on the second system image file that is started, and setting the startup offset value as the second offset value when the upgrade is successfully completed.

3. The method for protecting a system from being powered off abnormally during an upgrade of claim 1, wherein in Step S3, the step of performing the upgrade operation on the second system image file further comprises the steps of:
Step S31, determining whether the second system image file is successfully upgraded,
if the result shows “YES”, turning to Step S32;
if the result shows “NO”, turning to Step S33;
Step S32, after setting the startup offset value as the second offset value, turning to Step S4;
Step S33, generating a prompt message indicating that the upgrade fails, and exiting.

4. The method for protecting a system from being powered off abnormally during an upgrade of claim 1, wherein in Step S4, the step of performing the upgrade operation on the first system image file that is started further comprises the steps of:
Step S41, determining whether the first system image file is successfully upgraded,
if the result shows “YES”, turning to Step S42;
if the result shows “NO”, turning to Step S43;
Step S42, setting the startup offset value as the first offset value, and exiting; and
Step S43, after saving the startup offset value as the second offset value, the terminal device starts the second system image file based on the second offset value when restarted.

5. The method for protecting a system from being powered off abnormally during an upgrade of claim 1, wherein the size of each of the plurality of storage partitions is more than twice the size of the saved first image file, or is more than twice the size of the second image file.

6. The method for protecting a system from being powered off abnormally during an upgrade of claim 1, wherein the terminal device further comprises a boot partition, and the boot partition is configured for saving a boot loader.

7. A terminal device applicable to a method for protecting a system from being powered off abnormally during an upgrade, wherein the terminal device comprises a plurality of storage partitions, each of the plurality of storage partitions stores a first system image file, a second system image file, a first offset value corresponding to the first system image file, and a second offset value corresponding to the second system image file respectively; and the method comprises the steps of:
Step S1, acquiring a startup offset value of one of the plurality of storage partitions;
Step S2, when the startup offset value is the first offset value, starting the first system image file;
Step S3, acquiring an upgrade file, performing an upgrade operation on the second system image file in the current storage partition by using the acquired upgrade file, and setting the startup offset value as the second offset value when the upgrade is successfully completed; and
Step S4, continuing to perform the upgrade operation on the first system image file that is started, and setting the startup offset value as the first offset value when the upgrade is successfully completed.

8. The terminal device of claim 7, wherein when the startup offset value is the second offset value, the method performs the steps of:
Step A1, starting the second system image file;
Step A2, acquiring the upgrade file, performing an upgrade operation on the first system image file in the current storage partition by using the acquired upgrade file, and setting the startup offset value as the first offset value when the upgrade is successfully completed; and
Step A3, continuing to perform the upgrade operation on the second system image file that is started, and setting the startup offset value as the second offset value when the upgrade is successfully completed.

9. The terminal device of claim 7, wherein in Step S3, the step of performing the upgrade operation on the second system image file further comprises the steps of:
Step S31, determining whether the second system image file is successfully upgraded,
if the result shows “YES”, turning to Step S32;
if the result shows “NO”, turning to Step S33;
Step S32, after setting the startup offset value as the second offset value, turning to Step S4;
Step S33, generating a prompt message indicating that the upgrade fails, and exiting.

10. The terminal device of claim 7, wherein in Step S4, the step of performing the upgrade operation on the first system image file that is started further comprises the steps of:
Step S41, determining whether the first system image file is successfully upgraded,
if the result shows “YES”, turning to Step S42;
if the result shows “NO”, turning to Step S43;
Step S42, setting the startup offset value as the first offset value, and exiting; and
Step S43, after saving the startup offset value as the second offset value, the terminal device starts the second system image file based on the second offset value when restarted.

11. The terminal device of claim 7, wherein the size of each of the plurality of storage partitions is more than twice the size of the saved first image file, or is more than twice the size of the second image file.

12. The terminal device of claim 7, wherein the terminal device further comprises a boot partition, and the boot partition is configured for saving a boot loader.
